(19) United States
(12) Patent Application Publication
(10) Pub. No.: US 2019/0159220 A1
(43) Pub. Date: May 23, 2019

(54) METHODS AND SYSTEMS FOR UPLINK MU-MIMO SCHEDULING

(71) Applicant: QUALCOMM Incorporated, San Diego, CA (US)

(72) Inventors: Ahmed Ragab Elsherif, San Jose, CA (US); Srinivas Katar, Fremont, CA (US)

(21) Appl. No.: 15/816,884

(22) Filed: Nov. 17, 2017

(51) Int. Cl. H04W 72/12; H04B 7/0452; H04W 28/02; H04W 72/04; H04L 1/00

(52) U.S. Cl. CPC H04W 72/12; H04B 7/0452; H04W 88/08; H04W 72/0413; H04L 1/0003; H04W 28/0278

(57) ABSTRACT

Uplink multi-user multiple-in, multiple-out (UL MU-MIMO) transmissions involve coordinating or scheduling stations communications with an access point. Methods and systems for scheduling UL MU-MIMO transmissions provide selection of stations permitted to communicate during the UL MU-MIMO transmission. One such method includes transmitting a first trigger message that requests each station to transmit a second message to the access point. The method also includes receiving the second messages from responding stations and estimating, based on the second messages, one or more parameters for each responding station. The method further includes generating a schedule for the stations to transmit data to the access point and transmitting a second trigger message to the stations, the second trigger message identifying the schedule and the stations that are scheduled to transmit UL data to the access point according to the schedule. The method also includes receiving data during the UL MU-MIMO transmission opportunity from the stations.

### TECHNICAL FIELD

This application relates generally to wireless communication, and more specifically to systems and methods for scheduling uplink multi-user multiple input, multiple output communications.

### BACKGROUND

Wireless communications systems are widely deployed to provide various types of communication content such as voice, video, packet data, messaging, broadcast, and so on. The wireless communications systems may utilize communications networks to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, SONET (Synchronous Optical Networking), Ethernet, etc.).

Wi-Fi or WiFi (e.g., IEEE 802.11) is a technology that allows electronic devices to connect to the WLAN. A WiFi network may include an access point (AP) that may communicate with one or more other electronic devices (e.g., computers, cellular phones, tablets, laptops, televisions, wireless devices, mobile devices, “smart” devices, etc.), which can be referred to as stations (STAs). The AP may be coupled to a network, such as the Internet, and may enable one or more STAs to communicate via the network or with other STAs coupled to the AP. Wireless networks are often preferred when the network elements (e.g., APs or STAs) are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

Many wireless networks utilize carrier-sense multiple access with collision detection (CSMA/CD) to share a wireless medium. With CSMA/CD, before transmission of data on the wireless medium, a device may listen to the medium to determine whether another transmission is in progress. If the medium is idle, the device may attempt a transmission. The device may also listen to the medium during its transmission, so as to detect whether the data was successfully transmitted, or if perhaps a collision with a transmission of another device occurred. When a collision is detected, the device may wait for a period of time and then re-attempt the transmission. The use of CSMA/CD allows for a single device to utilize a particular channel (such as a spatial or frequency division multiplexing channel) of a wireless network.

Users continue to demand greater and greater capacity from their wireless networks. For example, video streaming over wireless networks is becoming more common. Video teleconferencing may also place additional capacity demands on wireless networks. In order to satisfy the bandwidth and capacity requirements users require, improvements in the ability of a wireless medium to carry and communicate larger and larger amounts of data are needed.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

In one aspect, a method of scheduling an uplink multi-user multiple-in, multiple-out (UL MU-MIMO) transmission opportunity is disclosed. The method comprises transmitting, by an access point, a first trigger message to a plurality of stations. The first trigger message requests that the stations each transmit a second message to the access point. The method further comprises receiving, by the access point, the second messages from one or more responding stations of the plurality of stations and estimating or obtaining, based on the second messages, one or more parameters for each responding station or each communication link between the access point and each responding station of the plurality of stations. The method also comprises generating a schedule for the stations to transmit data in an UL MU-MIMO transmission opportunity to the access point. The schedule is generated to indicate at least a subset of the plurality of stations that are scheduled to transmit data. The method also further comprises transmitting a second trigger message to the plurality of stations. The second trigger message identifies the subset of the plurality of stations that are scheduled to transmit UL data to the access point during the UL MU-MIMO transmission opportunity. The method further also comprises receiving data during the UL MU-MIMO transmission opportunity from the subset of the plurality of stations.

In another aspect, an apparatus for scheduling an uplink multi-user multiple-in, multiple-out (UL MU-MIMO) transmission opportunity is disclosed. The apparatus comprises a communication circuit and a processing circuit. The communication is configured to transmit a first trigger message to a plurality of stations, the first trigger message requesting that the stations each transmit a second message to the access point and receive the second messages from one or more responding stations of the plurality of stations. Each station of the plurality of stations communicates with the communication circuit over one of a plurality of communication links. The processing circuit is configured to estimate or obtain, based on the second messages, one or more parameters for each responding station or each communication link between the communication circuit and each responding station and generate a schedule for the stations to transmit data in an UL MU-MIMO transmission to the communication circuit, wherein the schedule indicates at least a subset of the plurality of stations. The communication circuit is further configured to transmit a second trigger message to the plurality of stations, the second trigger message identifying the subset of the plurality of stations that are scheduled to transmit UL data to the communication circuit during the UL MU-MIMO transmission opportunity and receive data during the UL MU-MIMO transmission opportunity from the subset of the plurality of stations.

An additional aspect of apparatus for scheduling an uplink multi-user multiple-in, multiple-out (UL MU-MIMO) transmission opportunity is disclosed. The apparatus comprises means for transmitting a first trigger message to a plurality of stations, the first trigger message requesting that the stations each transmit a second message to the apparatus, wherein each station of the plurality of stations communicates with the apparatus over one of a plurality of communication links. The apparatus also comprises means for receiving the second messages from one or more responding stations of the plurality of stations and means for estimating or obtaining, based on the second messages, one or more parameters for each responding station or each communication link between the apparatus and each responding station. The apparatus further comprises means for generating a schedule for the stations to transmit data in an UL MU-MIMO transmission opportunity to the apparatus, wherein the schedule indicates at least a subset of the plurality of stations and means for transmitting a second trigger message to the plurality of stations, the second trigger message identifying the subset of the plurality of stations that are scheduled to transmit UL data to the access point during the UL MU-MIMO transmission opportunity. The apparatus also further comprises means for receiving data during the UL MU-MIMO transmission opportunity from the subset of the plurality of stations.

### BRIEF DESCRIPTION OF THE DRAWINGS

FIG. 1 schematically illustrates an example wireless communication system in which aspects of the present disclosure may be employed.

FIG. 2 schematically illustrates an example wireless device that may be employed within the example wireless communication system of FIG. 1.

FIG. 3 schematically illustrates an example configuration of a MIMO wireless communication system in accordance with certain embodiments described herein.

FIG. 4 schematically illustrates example communication options compatible with a MIMO wireless communication system in accordance with certain embodiments described herein.

FIG. 5 schematically illustrates a plurality of basic service sets (BSSs) of an exemplary MIMO wireless communication system.

FIG. 6 schematically illustrates an exemplary communication option for scheduling uplink (UL) multiuser (MU) transmissions in the MIMO wireless communication system of FIG. 4.

FIG. 7 schematically illustrates another example communication option for scheduling uplink (UL) multiuser (MU) transmissions in the MIMO wireless communication system of FIG. 4.

FIG. 8 is a flowchart of an exemplary method of scheduling uplink transmissions between stations and an access point.

### DETAILED DESCRIPTION

Various aspects of the novel systems, apparatuses, and methods are described more fully hereinafter with reference to the accompanying drawings. The teachings of the disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently or combined with any other aspect of the disclosure. In addition, the scope is intended to cover such an apparatus or method which is practiced using other structure and functionality as set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The word “exemplary” is used herein to mean “serving as an example, instance, or illustration.” Any implementation described herein as “exemplary’ is not necessarily to be construed as preferred or advantageous over other implementations. The following description is presented to enable any person skilled in the art to make and use the embodiments described herein. Details are set forth in the following description for purpose of explanation. It should be appreciated that one of ordinary skill in the art would realize that the embodiments may be practiced without the use of these specific details. In other instances, well known structures and processes are not elaborated in order not to obscure the description of the disclosed embodiments with unnecessary details. Thus, the present application is not intended to be limited by the implementations shown, but is to be accorded with the widest scope consistent with the principles and features disclosed herein.

Wireless access network technologies may include various types of wireless local area access networks (WLANs). A WLAN may be used to interconnect nearby devices together, employing widely used access networking protocols. The various aspects described herein may apply to any communication standard, such as Wi-Fi or, more generally, any member of the IEEE 802.11 family of wireless protocols.

In some implementations, a WLAN includes various devices which access the wireless access network. For example, there may be: access points (also referred to as “APs”) and clients (also referred to as stations or “STAs”). In general, an AP serves as a hub or a base station for the STAs in the WLAN. A STA may be a laptop computer, a personal digital assistant (PDA), a mobile phone, etc. In an example, an STA connects to an AP via a Wi-Fi (e.g., IEEE 802.11 protocol such as 802.11ah) compliant wireless link to obtain general connectivity to the Internet or to other wide area access networks. In some implementations, an STA may also be used as an AP.

An AP may comprise, be implemented as, or known as a NodeB, Radio Access network Controller (“RNC”), eNodeB (“eNB”), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A STA may also comprise, be implemented as, or known as a user terminal, an access terminal (“AT”), a subscriber station, a subscriber unit, a mobile station, a remote station, a remote terminal, a user agent, a user device, a user equipment, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, a Node-B (Base-station), or any other suitable device that is configured to communicate via a wireless medium.

The techniques described herein may be used for various wireless communication networks such as Code Division Multiple Access (CDMA) networks, Spatial Division Multiple Access (SDMA), Time Division Multiple Access (TDMA) networks, Frequency Division Multiple Access (FDMA) networks, Orthogonal FDMA (OFDMA) networks, Single-Carrier FDMA (SC-FDMA) networks, and so forth. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). The cdma2000 covers IS-2000, IS-95 and IS-856 standards. An SDMA system may utilize sufficiently different directions to simultaneously transmit data belonging to multiple user terminals. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). These various radio technologies and standards are known in the art.

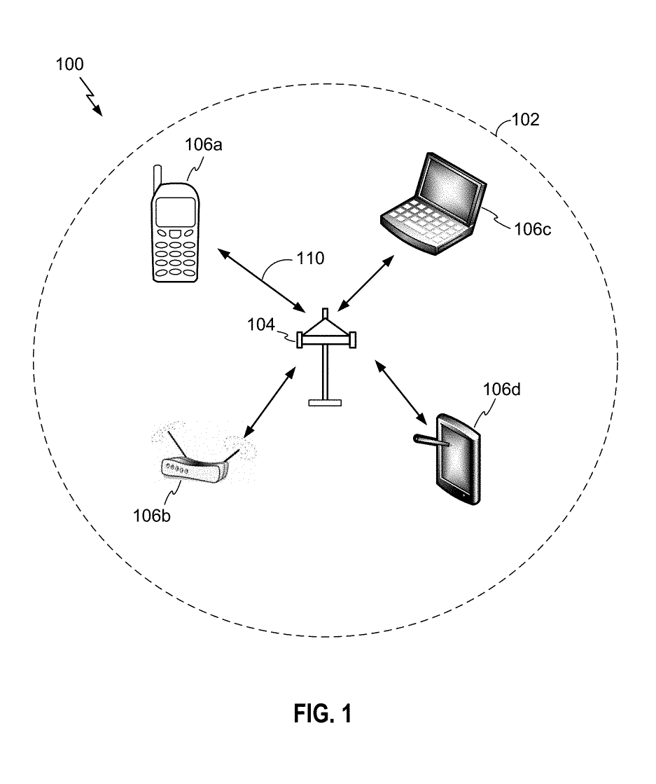

FIG. 1 is a diagram that illustrates a multiple-access multiple-input multiple-output (MIMO) system 100 with APs 104 and STAs 106a-d. For simplicity, only one AP 104 is shown in FIG. 1. As described above, the AP 104 communicates with the STAs 106a-d (also referred to herein collectively as “the STAs 106” or individually as “the STA 106”). The STA 106 may also be referred to as a base station or using some other terminology. Also, as described above, the STA 106 may be fixed or mobile and may also be referred to as a user terminal, a mobile station, a wireless device, or using some other terminology. The AP 104 may communicate with one or more STAs 106 at any given moment via communications link 110. The communication link 110 that facilitates transmission from the AP 104 to one or more of the STAs 106 may be referred to as a downlink (DL), and the communication link 110 that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel. A STA 106 may also communicate peer-to-peer with another STA 106.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network (e.g. TDLS, WiFi-Direct) between the STAs 106. Accordingly, the functions of the AP 104 described herein may alternatively be performed by one or more of the STAs 106.

Portions of the following disclosure will describe STAs 106 capable of communicating via any of the communication networks described above (e.g., SDMA). Thus, for such aspects, the AP 104 may be configured to communicate with both SDMA and non-SDMA STAs. This approach may conveniently allow older versions of STAs (e.g., “legacy” STAs) that do not support SDMA to remain deployed in an enterprise, extending their useful lifetime, while allowing newer SDMA STAs to be introduced as deemed appropriate.

The MIMO system 100 may employ multiple transmit and multiple receive antennas for data transmission on the downlink and uplink. For example, the AP 104 may be equipped with N antennas and represents the multiple-input (MI) for downlink transmissions and the multiple-output (MO) for uplink transmissions. A set of K selected STAs 106 collectively represents the multiple-output for downlink transmissions and the multiple-input for uplink transmissions. For pure SDMA, it may be desired to have N<K<1 if the data symbol streams for the K STAs 106 are not multiplexed in code, frequency or time by some means. K may be greater than N if the data symbol streams can be multiplexed using TDMA technique, different code channels with CDMA, disjoint sets of sub-bands with OFDM, and so on. Each selected STA 106 may transmit user-specific data to and/or receive user-specific data from the AP 104. In general, each selected STA 106 may be equipped with one or multiple antennas (i.e., M The K selected STAs 106 can have the same number of antennas, or one or more STAs 106 may have a different number of antennas than other STAs 106 or the AP 104.

The MIMO system 100 may be a time division duplex (TDD) system or a frequency division duplex (FDD) system. For a TDD system, the downlink and uplink share the same frequency band. For an FDD system, the downlink and uplink use different frequency bands. The MIMO system 100 may also utilize a single carrier or multiple carriers for transmission. Each STA 106 may be equipped with a single antenna (e.g., to keep costs down) or multiple antennas (e.g., where the additional cost can be supported). The MIMO system 100 may also be a TDMA system if the STAs 106 share the same frequency channel by dividing transmission/reception into different time slots, where each time slot may be assigned to a different STA 106.

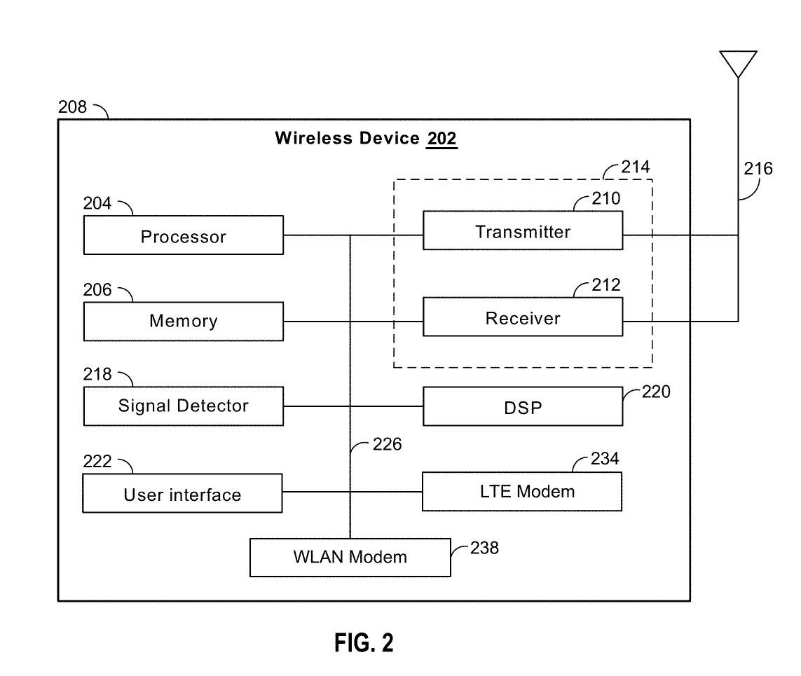

FIG. 2 illustrates various components that may be utilized in a wireless device 202 that may be employed within the wireless communication MIMO system 100. The wireless device 202 is an example of a device that may be configured to implement the various methods described herein. The wireless device 202 may implement one or both of the AP 104 or the STA 106.

The wireless device 202 may include an electronic hardware processor (also referred to as a “processor”) 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 may perform logical and arithmetic operations based on program instructions stored within the memory 206. The instructions in the memory 206 may be executable to implement the methods described herein.

The processor 204 may comprise or be a component of a processing system implemented with one or more electronic hardware processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and a receiver 212 to allow transmission and reception of data between the wireless device 202 and a remote location and/or device. The transmitter 210 and receiver 212 may be combined into a transceiver 214. A single or a plurality of transceiver antennas 216 may be attached to the housing 208 and electrically coupled to the transceiver 214. The wireless device 202 may also include (not shown) multiple transmitters, multiple receivers, and multiple transceivers.

The wireless device 202 may also include a signal detector 218 that may be used to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. In some aspects, the wireless device may also include one or more of a user interface component 222, cellular modem 234, and a wireless LAN (WLAN) modem 238. The cellular modem 234 may provide for communication using cellular technologies, such as CDMA, GPRS, GSM, UTMS, or other cellular networking technology. The WLAN modem 238 may provide for communications using one or more WiFi technologies, such as any of the IEEE 802.11 protocol standards.

The various components of the wireless device 202 may be coupled together by a bus system 226, which may include a power bus, a control signal bus, and a status signal bus in addition to a data bus.

Certain aspects of the present disclosure support transmitting an uplink (UL) signal or a downlink (DL) signal between one or more STAs 106 and an AP 104. In some embodiments, the signals may be transmitted in a multi-user MIMO (MU-MIMO) system. Alternatively, the signals may be transmitted in a multi-user FDMA (MU-FDMA) or similar FDMA system.

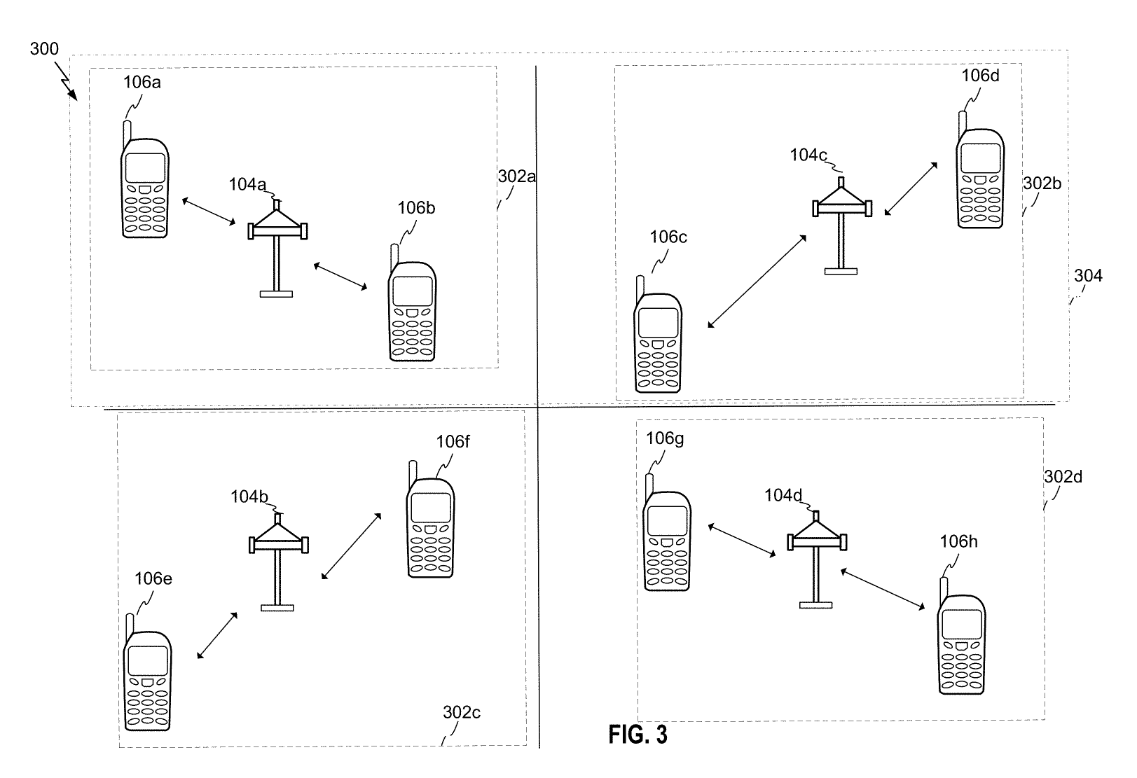

FIG. 3 shows four basic service sets (BSSs) 302a-d, each BSS including an access point 104a-d, respectively. Each access point 104a-d is associated with at least two stations within its respective BSS 302a-d. AP 104a is associated with STA 106a-b. AP 104b is associated with STA 106c-d. AP 104c is associated with STA 106e-f. AP 104d is associated with STAs 106g-h. An AP 104 that is associated with a STA 106 may be referred to as a BSS AP for the STA throughout this disclosure. Similarly, an AP 104 for which there is no association with a particular STA 106 may be referred to as an OBSS AP for the STA throughout this disclosure. Associations between an AP 104 and one or more STAs 106 provides for, in part, coordination of communication between devices within the basic service set (BSS) defined by the AP 104 and its associated STAs 106. For example, devices within each BSS may exchange signals with each other. The signals may function to coordinate transmissions from the respective AP 104a-d and stations within the AP's BSS 302a-d.

The devices shown in FIG. 3, including the AP's 104a-d and STA 106a-h, also share a wireless medium. Sharing of the wireless medium is facilitated, in some aspects, via the use of carrier sense media access with collision detection (CSMA/CD). The disclosed embodiments may provide for a modified version of CSMA/CD that provides for an increase in an ability for the BSSs 302a-d to communicate simultaneously when compared to known systems.

The stations 106a-h within the BSSs 302a-d may have different abilities to receive transmissions from their associated AP based, at least in part, on their position relative to the other APs 104 and/or STAs 106 outside their respective BSS (OBSS). For example, because the stations 106a, 106d, 106e, and 106h are positioned relatively far from OBSS APs, these stations may have an ability to receive transmissions from their respective BSS AP even with an OBSS AP or STA is transmitting. Stations having such receive characteristics may be referred to as Reuse STAs throughout this disclosure. Reuse STAs may have sufficient signal to noise ratios (SINRs) with OBSS APs that they may communicate with other STAs and/or APs without having to be nulled.

In contrast, STAs 106b, 106c, 106f, and 106g are illustrated in positions that are relatively close to an OBSS AP. Thus, these stations may have less ability to receive transmissions from their BSS AP during transmissions from OBSS AP's and/or OBSS STAs. Stations having such receive characteristics may be referred to as non-reuse or edge STAs throughout this disclosure. Non-reuse STAs may have insufficient signal to noise ratios (SINRs) with OBSS APs that they may be nulled to communicate with other STAs and/or APs while communications are occurring involving the OBSS APs. In some aspects, the disclosed methods and systems may provide for an improved ability for the non-reuse STAs to communicate concurrently while other OBSS devices are also communicating on the wireless medium.

In at least some of the disclosed aspects, two or more of the APs 104a-d may negotiate to form a cluster of access points. In other aspects, cluster configurations may be defined via manual configuration. For example, each AP may maintain configuration parameters indicating whether the AP is part of one or more cluster, and if so, a cluster identifier for the cluster. In some aspects, the configuration may also indicate whether the AP is a cluster controller for the cluster. In some of the embodiments disclosed herein, a cluster controller may take on functions that differ from APs that are part of the cluster but are not a cluster controller. Thus, in some aspects, two or more of APs 104a-d may be included in the same cluster. STAs associated with those access points may also be considered to be included in or part of the cluster of their associated AP. Therefore, in some aspects the STAs a-h illustrated above may be part of the same cluster.

The cluster of access points may coordinate transmissions between themselves and their associated APs. In some aspects, the cluster may be identified via a cluster identifier that uniquely identifies the group of access points comprising the cluster. In some aspects, during association of a station with any of the APs in a cluster, the cluster identifier is transmitted to the station during association, for example, in an association response message. The station may then utilize the cluster identifier to coordinate communications within the cluster. For example, one or more messages transmitted over the wireless network may include the cluster identifier, which a receiving STA may use to determine whether the message is addressed to it or not.

In certain embodiments cluster access points may also utilize various methods to identify STAs within the cluster. For example, as known methods of generating association identifiers (AIDs) may not provide uniqueness across access points, in some aspects, media access control (MAC) addresses may be utilized to identify stations where appropriate. For example, known messages including user info fields that utilize association identifiers to identify stations may be modified to contain data derived from station MAC addresses in the disclosed embodiments. Alternatively, methods of generating association identifiers may be modified to ensure uniqueness within a cluster of access points. For example, a portion of the association identifier may uniquely identify an access point within the cluster. Stations associated with that access point would be assigned association identifiers including the unique identification. This provides unique association identifiers across access points within a cluster. In some other aspects, an association identifier within a cluster may include the cluster identifier. This may provide for uniqueness across clusters to facilitate future cross-cluster coordination of communication.

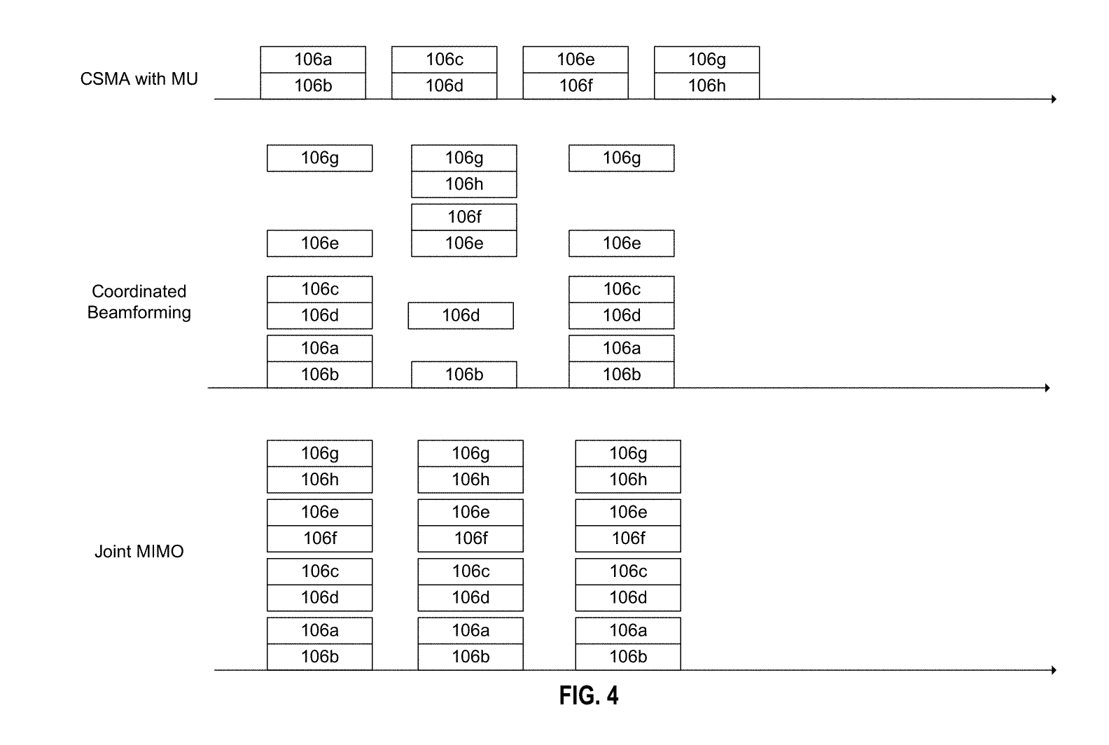

FIG. 4 shows three exemplary approaches to arbitrating the wireless medium within the communication system 300 of FIG. 3. Approach 405 utilizes carrier sense media access (CSMA) to perform single BSS multi-user transmissions. For example, each of transmissions 420a-d may be performed by the BSSs 302a-d of FIG. 3, respectively. The use of traditional CSMA in the approach 405 causes the medium to be utilized by only one BSS at any point in time.

Approach 410 utilizes coordinated beamforming (COBF). With the coordinated beamforming approach 410, the APs 104a-d may coordinate transmissions between their respective BSSs. In some aspects, this coordination may be performed over the wireless medium, or in some aspects, over a back-haul network. In these aspects, the coordination traffic over the backhaul network improves utilization of the wireless medium.

With this approach, reuse STAs for different BSSs may be scheduled to transmit or receive data concurrently. For example, a relative strength of a communication channel between STA 106a and AP 104a may allow these two devices to exchange data simultaneously with communication with OBSS devices, such as, for example, AP 104b and STA 106d. In addition, the approach 410 allows scheduling of non-reuse STAs to transmit concurrently with OBSS devices. For example, STA 106b, which is within BSS 302, may be scheduled to communicate simultaneous with communication between AP 104d and STA 106h of BSS 302d. Such simultaneous communication between a non-reuse STA (such as STA 106b) and, for example, AP 104d may be facilitated by scheduling AP 104d to transmit a signal to STA 106b simultaneous with AP 104d's transmission to STA 106h. For example, AP 104d may transmit a null signal for dominant interfering signals to STA 106b. Thus, while transmitting a first signal to STA 106h, AP 104d may simultaneously transmit a signal nulling the first signal to STA 106b. Such simultaneous transmission by the AP 104d may be provided by selecting individual antenna(s) of a plurality of antennas provided by AP 104d for each of the transmissions. Such nulling may create reuse opportunities for otherwise non-reuse STAs. COBF may operate in both DL and UL directions with the APs 104 nulling respective frequencies.

The approach 415 shows an exemplary multi-user communication or a MIMO communication across APs 104a-d within the BSSs 302a-d. With this MIMO approach 415, a cluster of APs (such as APs 104a-d) may service N 1-SS STAs simultaneously, where N is ˜¾ of a total number of antennas across all APs within the cluster. MIMO communications may coordinate a collection of antennas across the multiple APs within a cluster to transmit to stations within the cluster. Thus, while traditional MIMO methods allocate transmit antennas within a single BSS to stations within the BSS, MIMO communication provides for allocation of transmit antennas outside a BSS to facilitate communications with stations within the BSS.

In a MIMO communication, a station in one BSS may communicate with one or more access points in another, different BSS. Thus, for example, station 106a of BSS 302a of FIG. 3 may communicate with access point 104d, which is in BSS 302d. This communication may occur simultaneously with communication between STA 106a and AP 104a, the BSS AP of the STA 106a. In some aspects of an uplink MIMO communication, the STA 106a may conduct one or more uplink communications to AP 104a simultaneously with AP 104d. Alternatively, a downlink MIMO communication may include AP 104a transmitting data to STA 106a simultaneously with a transmission from AP 104d to STA 106a.

Thus, one or more of the embodiments may utilize MIMO in the form of Cooperative Multipoint (CoMP, also referred to as e.g. Network MIMO (N-MIMO), Distributed MIMO (D-MIMO), or Cooperative MIMO (Co-MIMO), etc.) transmission, in which multiple access points maintaining multiple corresponding basic service sets, can conduct respective cooperative or joint communications with one or more STAs 106. CoMP communication between STAs and APs can utilize for example, a joint processing scheme, in which an access point associated with a station (a BSS AP) and an access point that is not associated with a station (a OBSS AP) cooperate to engage in transmitting downlink data to the STA and/or jointly receiving uplink data from the STA. Additionally, or alternatively, CoMP communication between an STA and multiple access points can utilize coordinated beamforming, in which a BSS AP and an OBSS AP can cooperate such that an OBSS AP forms a spatial beam for transmission away from the BSS AP and, in some aspects, at least a portion of its associated stations, thereby enabling the BSS AP to communicate with one or more of its associated stations with reduced interference.

To facilitate the coordinated beamforming approach 410 or the joint MIMO approach 415, an understanding of channel conditions between an access point and OBSS devices may provide for greater wireless communication efficiency.

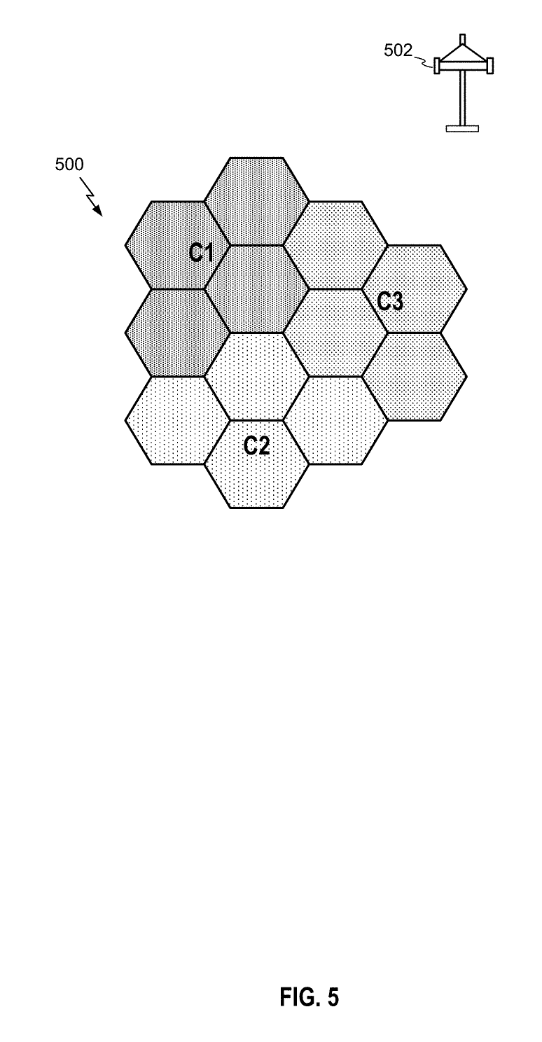

FIG. 5 schematically illustrates a plurality of basic service sets (BSSs) 500 of an exemplary MIMO wireless communication system. Each hexagon of FIG. 5 represents an access point and associated stations, collectively referred to as a basic service set (BSS). The individual BSSs are grouped into clusters in accordance with certain embodiments described herein. In the example schematically illustrated by FIG. 5, a first cluster (C1) comprises four BSSs, a second cluster (C2) comprises four BSSs, and a third cluster (C3) comprises four BSSs. In certain other embodiments, a cluster can comprise 2, 3, 4, 5, or any numbers of BSSs and a wireless communication system can comprise one or more clusters (e.g., 2, 3, 4, 5 or other numbers of clusters). A cluster controller 502 is also shown. The cluster controller 502 may comprise an AP 104 or another standalone component as described herein. The cluster controller 502 may identify clusters of BSSs based on various BSS parameters.

In certain embodiments, to perform MIMO communications, devices within two or more BSSs of a cluster may transmit over a single channel simultaneously (e.g., transmit data from a plurality of access points of the BSS simultaneously via the single channel, or transmit data from a plurality of stations in different BSSs simultaneously to a single AP). In some aspects, a centralized scheduler (not shown) may coordinate transmissions across the clusters C1-C3. For example, coordination may include selecting which devices will transmit simultaneously from multiple BSSs to perform a joint MIMO communication.

Under European Telecommunications Standard Institute (ETSI) regulations, wireless communication systems are generally required to utilize clear channel assessment (CCA) or listen-before-talk (LBT) before allowing access to the wireless network. Generally, two different access modes are allowed in such wireless communication systems: “frame-based” access mode and “load-based” access mode. To utilize coordinated access in an unlicensed spectrum, it is generally desirable for a device on the wireless network to use a safe or allowed mechanism for ignoring same-network deferral while honoring LBT toward other devices on the wireless network. A similar issue arises with licensed assisted access (LAA) systems, which are bound to a fixed frame structure. However, in wireless communication systems which are not bound to a fixed frame structure (e.g., WiFi), a more flexible and/or efficient solution may be used. Certain embodiments described herein advantageously provide a way to enable reuse (e.g., stations able to serve simultaneously without having to be nulled) by synchronizing the physical layer convergence procedure (PLCP) protocol data unit (PPDU) start time, which may be seen as a forced collision. In certain such embodiments, the timing scheme is configured so that energy detect (ED) or power detect (PD) operations do not trigger within the same wireless network at the start of a frame (e.g., having a standard that defines requirements for CCA timing and synchronization).

In various Wi-Fi communication schemes, mechanisms for STAs to perform sounding for UL MU-MIMO transmissions are not defined, unlike sounding performed for DL MU-MIMO in 802.11ac and 802.11ax communication schemes. However, sounding (e.g., explicit sounding from the STAs to the AP) or other methods (e.g., implicit sounding) as described herein may be used to schedule UL MU-MIMO transmissions to improve or increase efficiency of the UL MU-MIMO transmissions and to optimize UL MU-MIMO transmission performance. For example, trigger frames and PPDUs from the STAs to the AP may be used to infer UL transmission statistics and information. Additional benefits of scheduling the UL MU-MIMO transmissions may include maintaining fairness of accessibility to the network among various users and STAs based on their traffic to communicate over the network.

When scheduling the UL MU-MIMO transmissions, various information and aspects that may impact UL MU-MIMO transmission performance are considered. For example, optimizing the UL MU-MIMO transmission performance may utilize information regarding which or whether users have threshold amounts of data to send in UL MU-MIMO transmissions. For example, the threshold may exist to exclude STAs or APs that have only small amounts of data for transmission that may not utilize the available bandwidth or UL PPDUs. Thus, STAs or APs that would not be able to fill an UL PPDU may be excluded from being scheduled for communication during the scheduled UL MU-MIMO transmission.

Furthermore, scheduling of the UL MU-MIMO transmission may involve excluding STAs or APs (or other devices) that have large clock frequency offsets (CFOs). Devices having large CFOs may reduce the performance of other devices in the UL MU-MIMO transmission. By excluding devices with large CFOs, the performance of the scheduled UL MU-MIMO transmission may be improved as compared to UL MU-MIMO transmissions that include devices with large CFOs. Not allowing devices with large CFOs to communicate prevents those devices from adversely impacting and disrupting the performance of other devices in the UL MU-MIMO transmission. The scheduling may also select devices that have a low channel correlation in UL MU-MIMO transmissions to optimize the achieved MU signal to noise plus interference ratio (SINR) and resulting UL MU-MIMO transmission throughput. For example, low channel correlation may correspond to channels being as close as possible to being orthogonal to each other. Thus, devices having low channel correlation may have channels that are close to orthogonal to each other. The low channel correlation may reduce an amount of cross interference that the devices cause to each other in UL MU-MIMO transmissions, which may result in an increase of a signal to noise plus interference ration (SINR).

Scheduling the UL MU-MIMO transmission may also involve selecting modulation coding schemes (MCSs) for each device participating in the UL MU-MIMO transmission. For example, the selected MCS for each device may be the maximum MCS that the device can support. By ensuring that each device uses the maximum MCS, transmission throughput during the UL MU-MIMO transmission may be improved or maximized. Additionally, the scheduling may also involve selecting a target received signal strength indicator (RSSI) for each participating device for the UL MU-MIMO transmission.

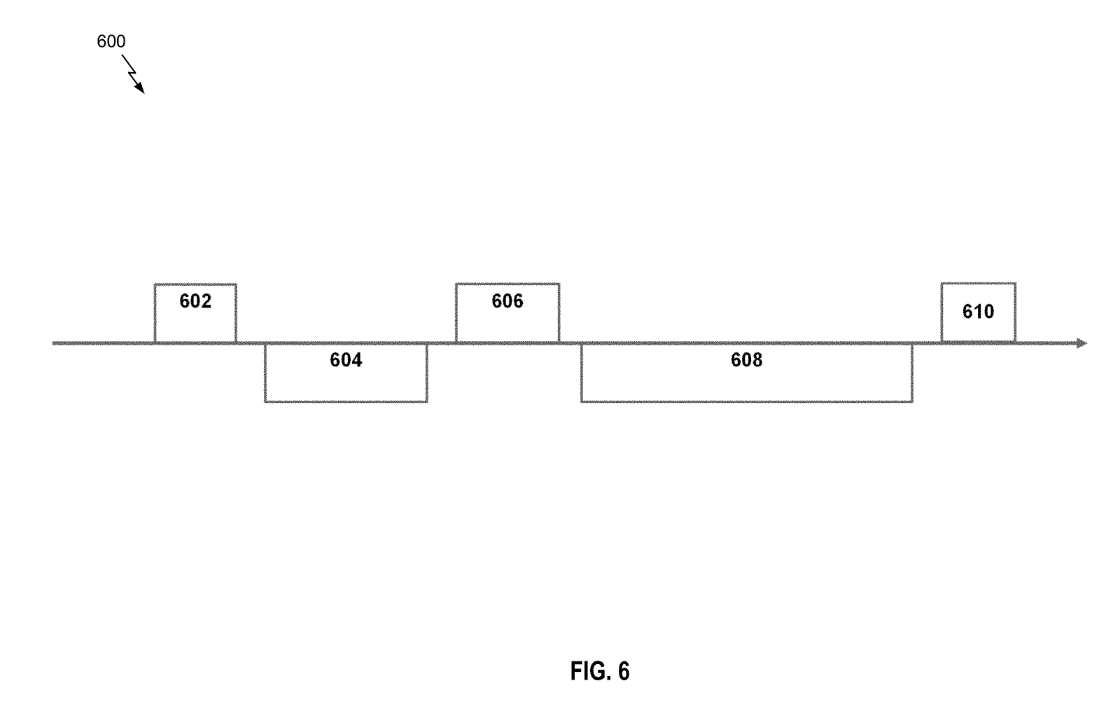

FIG. 6 schematically illustrates an exemplary communication exchange 600 for scheduling uplink (UL) multiuser (MU) transmissions in the MIMO wireless communication system 400 of FIG. 4. The communication exchange 600 may comprise two sets of communications. The first set of communications may be downlink communications from the one or more APs 104 to the one or more STAs 106. The second set of communications may be uplink communications from the one or more STAs 106 to the one or more APs 104.

As shown in the communication exchange 600, the AP 104 may perform an arbitration interframe spacing (AIFS) or other backoff procedure and then transmits a trigger frame 602. The trigger frame 602 is transmitted from the AP 104 to the STAs 106 requesting that each of the STAs 106 submit a first UL-triggered PPDU 604 in advance of their intended UL MU-MIMO transmissions. In some embodiments, the first UL-triggered PPDU 604 may be identified as a “Training HE TB PPDU”. The trigger frame 602 may provide the STAs 106 with one or more variables or parameters to include in the first UL-triggered PPDU 604 being triggered. In some embodiments, the AP 104 may use the trigger frame 602 to request that the first UL-triggered PPDU 604 have a specific size or duration (for example, a length of a few microseconds, corresponding to a specific number of MPDUs). Such a request may result in reduced overhead. In some embodiments, the trigger frame 602 may include a schedule of STAs 106 to transmit the first UL-triggered PPDU 604.

After the trigger frame 602 is transmitted from the one or more APs 104 to the one or more STAs 106, the one or more STAs 106 each transmits the first UL-triggered PPDU 604. Based on the first UL-triggered PPDUs 604 received from the one or more STAs 106, the one or more APs 104 may obtain and/or estimate one or more of the following parameters: (1) buffer status information for a corresponding STA 106, (2) a carrier frequency offset (CFO) estimate for each responding STA 106, (3) a correlation metric per UL MU-MIMO group (e.g., a correlation metric between the channels of the STAs in the UL MU-MIMO group), (4) an RSSI per STA, (5) an error vector magnitude (EVM) for each STA 106, and (6) a packet error rate (PER) for each STA 106. The AP 104 may use these obtained/estimated parameters to determine groups of STAs 106 to participate in UL MU-MIMO transmissions. In some embodiments, the correlation metric may be inferred from a condition number of the UL MU-MIMO channel (e.g., the closer the channel condition number is to “1”, the more orthogonal the channel is with other channels, and the larger the channel condition number is beyond “1”, the more correlated it is with other channels).

A media access control circuit (MAC) of the AP 104 may obtain the buffer status information for each STA 106 from a quality of service (QoS) null field of the first UL-triggered PPDU 604. The buffer status information may provide an indication of whether the STA 106 has data to transmit UL and/or an amount of data to transmit UL. A physical layer circuit (PHY) of the AP 104 may estimate a residual CFO error for each STA 106 from long training fields (LTFs) and/or data symbols included in the first UL-triggered PPDU 604. The CFO estimates may be provided to the MAC. The PHY may also determine correlation metrics for each STA 106 in the UL MU-MIMO group to be scheduled for either the first UL-triggered PPDU 604/704 or the second UL-triggered PPDU 608/708. The correlation metrics may reflect the level of channel correlation or orthogonality of channels of the scheduled STAs 106. These correlation metrics may be estimated based on estimated UL MU-MIMO channels of the STAs 106 scheduled to communicate. The correlation metrics may be communicated to the MAC for use in scheduling and/or grouping STAs 106 for the UL MU-MIMO transmission. The PHY may estimate the RSSI for each STA 106 from the LTFs and may communicate the RSSI to the MAC. The PHY may estimate the EVM for each STA from pilot signals. The MAC may calculate the packet error rate (PER) for each STA 106.

In some embodiments, both the first UL-triggered PPDU 604/704 and the second UL-triggered PPDU 608/708 may be high efficiency (HE) trigger-based (TB) PPDUs or UL-triggered PPDUs. Additionally, or alternatively, both the first UL-triggered PPDU 604/704 and the second UL-triggered PPDU 608/708 may be similarly structured (e.g., include similar fields, etc.) but of different lengths (e.g., different packet lengths). In some embodiments, the first UL-triggered PPDU 604/704 may be shorter than the second UL-triggered PPDU 608/708 to reduce an overhead of the first UL-triggered PPDU 604/704 (for example when the first UL-triggered PPDU 604/704 is used only for training, i.e. estimating the useful parameters for UL MU-MIMO scheduling).

The AP 104 may update one or more packet error rate (PER) tables stored in its memory based on updated long-term PERs determined for each STA 106. These updates may be based on the calculated PERs. Based on the updated PER table, the AP 104 may identify a PHY rate that maximizes a throughput rate for each STA 106. The throughput rate may be maximized at (PHY rate)*(1−PER). Alternatively, or additionally, the AP 104 may estimate a modulation coding scheme (MCS) for each STA 106 based on the estimated EVM. As used herein, “PHY Rate” may refer to a data rate from the PHY layer, which may exclude any overhead from the MAC layer or higher networking layers. The PHY rate may be predetermined or defined for different MCS values assuming only PHY layer with no other overheads from higher layers.

In some embodiments, the STA 106 selection or participation and scheduling in the UL MU-MIMO transmission may be based at least in part on the parameters obtained or estimated based on the first UL-triggered PPDU 604/704. In some embodiments, each of the parameters may be considered in selecting and scheduling the STAs 106. In some embodiments, a subset of the parameters may be considered in selecting and scheduling the STAs 106.

When selection and scheduling of the STAs 106 is based on the CFO error, the AP 104 may use the estimated CFO to update a long-term CFO error estimate for the STA 106. The AP may then compare the updated long-term CFO error estimate against a threshold CFO error. If the updated long-term CFO error estimate exceeds the threshold CFO error, then the AP 104 may exclude or disallow participation of the STA 106 in the UL MU-MIMO transmission. Thus, the STA 106 having the long-term CFO error that exceeds the threshold CFO error may not be scheduled to transmit during the UL MU-MIMO transmission.

When selection and scheduling of the STA 106 is based on the buffer status information, the AP 104 may select and schedule STAs 106 to communicate during the UL MU-MIMO transmission based on a MAC efficiency. Accordingly, the AP 104 may use the received buffer status information for each STA 106 in combination with the determined MCS recommendation for each STA 106 (based on the PER and/or EVM estimates) to identify the efficiencies of the STAs 106 and then select a subset of the STAs 106 accordingly.

When selection and scheduling of the STAs 106 is based on correlation metrics and EVM, the AP 104 may select STAs 106 having EVMs or correlation metrics that meet a specific threshold. For example, if the AP 104 determines, based on the received first UL-triggered PPDUs 604/704 that selecting and scheduling all (or a combination) STAs 106 would result in a large or high correlation metric (which would result in lower SINRs and/or EVMs for each STA 106), the AP 104 may exclude one or more of the STAs 106 from the UL MU-MIMO transmission based on their EVM not meeting a specified threshold. In some embodiments, the threshold may be dynamic based on the potential correlation metric and/or potential SINR/EVM.

When selection and scheduling of the STAs 106 is based on target RSSI selection, the AP 104 may utilize the estimated RSSI for each STA 106 based on the first UL-triggered PPDU 604/704. The AP 104 may use the estimated RSSI values to update long-term RSSI tracking values for each of the STAs 106 for a particular MCS. The AP 104 may infer or determine, based on a comparison of the long-term RSSI and the estimated RSSI for a given MCS, whether the STA 106 is moving toward or away from the AP 104. Based on the long-term RSSI and estimated RSSI values for the STAs 106 and the recommended MCS for each STA 106, the AP 104 may identify a target RSSI for inclusion in the trigger frame 606/706, based on which STAs 106 will be excluded from communicating during the UL MU-MIMO transmission (e.g., if their RSSI is lower than the threshold at the given MCS). In some embodiments (e.g., alternatively or additionally), if the RSSI for the STA 106 is lower than the threshold for the corresponding MCS, the AP 104 may reduce the MCS for that STA 106 to allow that STA 106 to communicate.

When selection and scheduling of the STAs 106 is based on the PER of the STAs 106, the AP 104 may generate and/or update one or more PER tables for each STA 106. The AP 104 may then use the first UL-triggered PPDU 604/704 to test specific MCS, N spatial streams (ss), or bandwidth (BW) selections. Accordingly, the AP 104 may specify in the trigger frame 602 what MCS, Nss, or BW should be used in the subsequent UL trigger PPDU to obtain information from which the PER at the specified MCS, Nss, or BW is identified. Accordingly, multiple rounds of triggers and responses may be used to fully populate the PER tables and estimate or identify STAs 106 for selection and scheduling.

In some embodiments, the AP 104 may use the first UL-triggered PPDU 604/704 to test various guard interval (GI) and/or LTF configurations to determine whether a PER for a STA 106 can be lowered with longer GIs or higher LTF modes. For example, the trigger frame 602 may specify particular GI and/or LTF parameters for the STAs 106 to use for the first UL-triggered PPDU 604/704 and estimate resulting PERs for the STAs 106 based on the specified GI and LTF parameters. The information obtained from such testing may allow the AP 104 to change the GI and/or LTF mode based on a current value of the PER for the STA 106. For example, if the PER for the STA 106 drops below a specified threshold as compared to prior PER values for the same STA 106 but at different GI and/or LTF modes, then the AP 104 can specify particular GI/LTF values to use or can exclude STAs 106 having PERs that are below the threshold.

In some embodiments, the scheduling of STAs 106 for participation in the UL MU-MIMO transmission may be dynamic. For example, the AP 104 may trigger the first UL-triggered PPDU 604/704 as needed as opposed to preceding each second UL-triggered PPDU 608/708 with the first UL-triggered PPDU 604/704. This may reduce overhead and allow for “on demand” or “dynamic” scheduling of the first UL-triggered PPDU 604/704. In some embodiments, the first UL-triggered PPDU 604/704 may be scheduled or “triggered” based on one or more of the following:
At a predetermined period for all or a sub-set of STAs 106
A determination that a timer or period has elapsed without an update to any of the STAs 106 scheduled in the upcoming UL MU-MIMO transmission
An update of UL MU-MIMO parameters from one or more STAs 106 scheduled in an upcoming UL MU-MIMO transmission shows a deviation larger than a certain threshold from the long-term tracked parameter
Testing is required to determine the PER of certain MCS, Nss, BW, GI, or LTF configuration for one or more STAs 106 scheduled in the upcoming UL MU-MIMO transmission

The groups may comprise the one or more STAs 106 that may be scheduled to transmit during the UL MU-MIMO transmission. In some embodiments, these parameters may also be used to determine long-term averages for the parameters that may be used in scheduling future UL MU-MIMO transmissions. Thus, the trigger frame 602 may not be required for each UL MU-MIMO transmission where the long-term averages were generated based on previous first UL-triggered PPDUs 604.

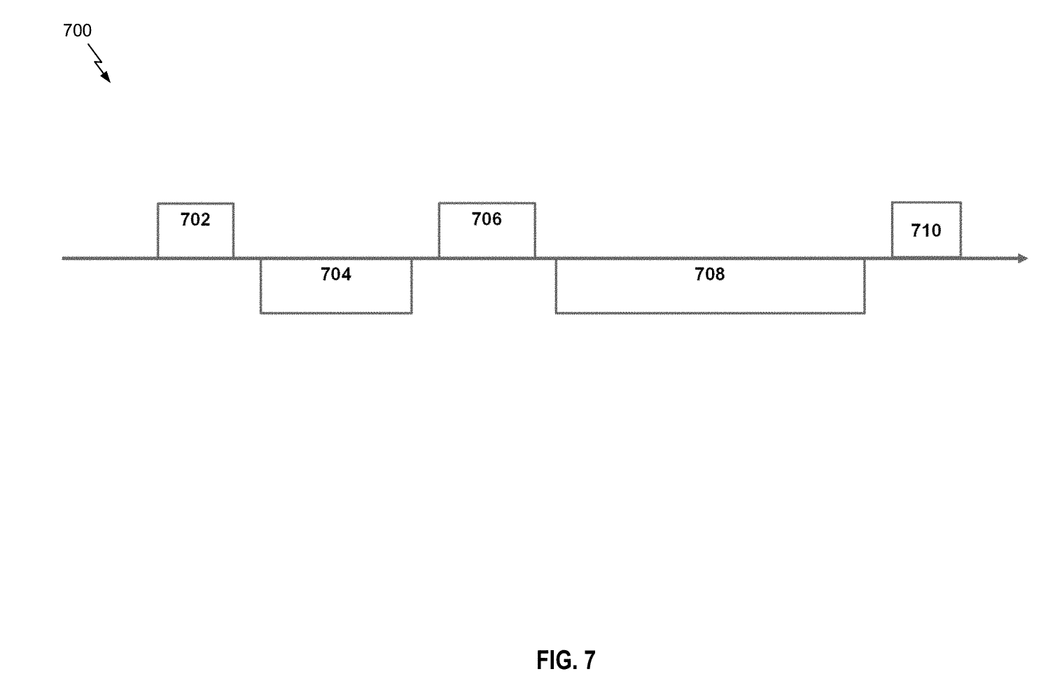

Once the groups of STAs 106 are determined, the AP 104 transmits a trigger frame 606 scheduling the UL MU-MIMO transmission. The trigger frame 606 may indicate which STAs 106 are scheduled to transmit their data in the UL MU-MIMO transmission that is to begin immediately following the trigger frame 606 or at a given time after the trigger frame 606. Individual STAs 106 may not be provided with specific time slots within the UL MU-MIMO transmission and instead be given freedom to communicate at any time during the UL MU-MIMO transmission. For example, whenever a STA 106 receives a trigger frame (e.g., trigger frame 606) with an AID matching the AID of the STA 106, the STA 106 should respond immediately (i.e., within a specified duration). Accordingly, as described herein, any STA 106 scheduled in the trigger frames 602/702 may respond immediately in the first UL-triggered PPDU 604/704. Similarly, any STA 106 scheduled in the trigger frames 606/706 may respond immediately in the second UL-triggered PPDU 608/708. However, the STAs 106 scheduled in in the trigger frames may be different, a subset, or the same. In some embodiments, the first UL-triggered PPDU 604/704 may be used for short data and may still include UL data while having a short duration. In some embodiments, individual STAs 106 may not be scheduled in the upcoming UL MU-MIMO transmission and may instead be scheduled in future UL MU-MIMO transmissions. Once the STAs 106 receive the trigger frame 606, the STAs 106 that are scheduled to communicate in the UL MU-MIMO transmission may begin communicating or may plan to communicate. In some embodiments, any STA 106 that is scheduled in the trigger frame 606 may respond immediately. Thus, the STAs 106 may transmit second UL-triggered PPDUs 608 to the APs 104 during the scheduled UL MU-MIMO transmission. The second UL-triggered PPDUs 608 transmitted by each scheduled STA 106 may include any UL data that the STA 106 has for communication to the AP 104. Once the STAs 106 complete their UL transmissions, the AP 104 may transmit block acknowledgements 610 to the STAs 106. In some embodiments, the trigger frames 602 and/or 606 may be considered basic trigger frames. The responses to these trigger frames may contain data and may or may not contain buffer status report (BSR) information. In FIG. 6, the trigger frames 602 and 606 may be basic trigger frames. In FIG. 7, the trigger frame 702 may be a buffer status report poll (BSRP) trigger frame while the trigger frame 706 may be a basic trigger frame. As used herein, a “basic trigger frame” is a trigger frame used to poll general UL data packets, but other types of trigger frames may be used for specific UL data or control info.

FIG. 7 schematically illustrates another example communication exchange 700 for scheduling uplink (UL) multiuser (MU) transmissions in the MIMO wireless communication system 400 of FIG. 4. The communication exchange 700 may comprise two sets of communications. The first set of communications may be downlink communications from the one or more APs 104 to the one or more STAs 106. The second set of communications may be uplink communications from the one or more STAs 106 to the one or more APs 104.

As shown in the communication exchange 700, the AP 104 may perform an arbitration interframe spacing (AIFS) or other backoff procedure and then may transmit a trigger frame 702. As noted above, the trigger frame 702 may be a buffer status report poll (BSRP) frame. The BSRP frame 702 may utilize less overhead than the trigger frame described in relation to the communication exchange 600. For example, the BSRP frame 702 may request a shorter UL trigger PPDU in response to the BSRP frame 702 as compared to the first UL-triggered PPDU 604 transmitted in response to the trigger frame 602. The BSRP frame 702 is transmitted from the AP 104 to the STAs 106 requesting that each of the STAs 106 submit the first UL-triggered PPDU 704 in advance of their intended UL MU-MIMO transmissions. In some embodiments, the BSRP (or other) trigger frame 702 may include a schedule of STAs 106 to transmit the first UL-triggered PPDU 704. The first UL-triggered PPDU 704 responding to the BSRP frame 702 may be shorter than the first UL-triggered PPDU 604 of FIG. 6. Thus, the overhead for the communication exchange 700 may be shorter than the overhead for the communication exchange 600. However, the first UL-triggered PPDU 704 may be shorter than the first UL-triggered PPDU 604 because the first UL-triggered PPDU 704 may include fewer parameters than the first UL-triggered PPDU 604. For example, the first UL-triggered PPDU 704 transmitted in response to the BSRP frame 702 may not include any data payload, making it shorter than the first UL-triggered PPDU 604. For example, the first UL-triggered PPDU 704 may not include necessary information for estimating the PER of the STA 106. However, the AP 104 receiving the first UL-triggered PPDU 704 may be able to estimate and/or obtain the remaining parameters identified above. The AP 104 may use these obtained/estimated parameters to determine groups of STAs 106 to participate in UL MU-MIMO transmissions. In some embodiments, the trigger frame 602 may include a schedule of STAs 106 to transmit the first UL-triggered PPDU 604. The groups may comprise the one or more STAs 106 that may be scheduled to transmit during the UL MU-MIMO transmission. In some embodiments, these parameters may also be used to determine long-term averages for the parameters that may be used in scheduling future UL MU-MIMO transmissions. Thus, the BSRP frame 702 or trigger frame 602 may not be required for each UL MU-MIMO transmission where the long-term averages were generated based on previous first UL-triggered PPDUs 604 and 704. The BSRP frame 702 and the corresponding trigger frame 706 may comprise an option for reduced overhead UL MU-MIMO transmissions and scheduling.

Once the groups of STAs 106 are determined, the AP 104 transmits a trigger frame 706 scheduling the UL MU-MIMO transmission. The trigger frame 706 may indicate which STAs 106 are scheduled to transmit their data in the UL MU-MIMO transmission that is to begin immediately following the trigger frame 706 or at a given time after the trigger frame 706. Individual STAs 106 may not be provided with specific time slots within the UL MU-MIMO transmission and instead be given freedom to communicate at any time during the UL MU-MIMO transmission. Once the STAs 106 receive the trigger frame 706, the STAs 106 that are scheduled to communicate in the UL MU-MIMO transmission may begin communicating or may plan to communicate. Thus, the STAs 106 may transmit the second UL-triggered PPDU 708 to the APs 104 during the scheduled UL MU-MIMO transmission. The second UL-triggered PPDU 708 transmitted by each scheduled STA 106 may include any UL data that the STA 106 has for communication to the AP 104. Once the STAs 106 complete their UL transmissions, the AP 104 may transmit block acknowledgements 710 to the STAs 106.

A mechanism, as disclosed herein, for UL MU-MIMO scheduling based on UL-triggered PPDUs used to estimate certain STA parameters pertinent to STA 106 and parameter selection for UL MU-MIMO transmissions may provide benefits of improved UL communication efficiencies and reduced overhead. The first UL-triggered PPDUs 604/704 may be short UL MU PPDUs used to estimate certain UL MU-MIMO scheduling related parameters, such as Buffer Status Information, CFO error estimates, channel correlation metrics, RSSI, EVM, and PER. Thus, the UL-triggered PPDUs may be used to estimate parameters for the STAs 106 or parameters of the UL communication links between the STAs 106 and the AP 104. The estimated parameters may be used for scheduling and selecting STAs 106 for the upcoming UL MU-MIMO transmission as well as to feed long-term averages of these parameters to aid in future UL MU-MIMO scheduling decisions.

As described herein, these parameters may be used for at least one of STA 106 selection for the upcoming UL MU-MIMO transmission, STA 106 MCS/Nss Selection (Rate Adaptation), Target RSSI selection, MCS/Nss/BW PER testing or probing, and GI/LTF mode selection. Furthermore, the UL-triggered PPDUs may be dynamically scheduled. In some embodiments, the trigger frames 702 and/or 706 may be considered buffer status report poll (BSRP) trigger frames. The responses to the BSRP frames may contain only buffer status report (BSR) information.

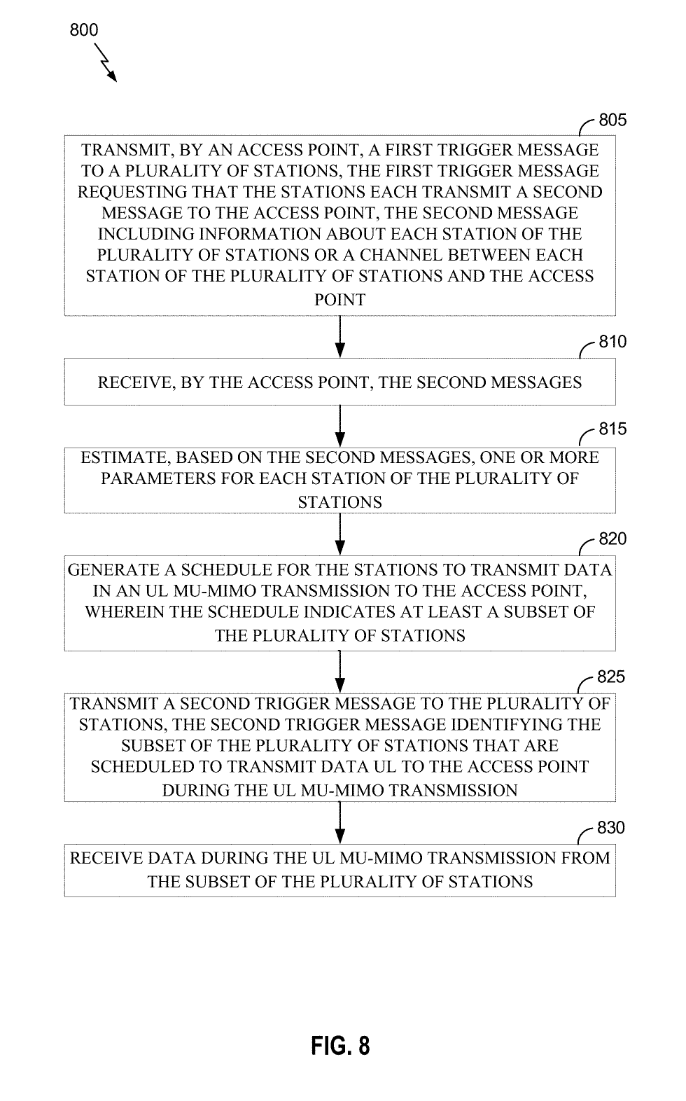

FIG. 8 is a flowchart of an exemplary method 800 of scheduling uplink transmissions between stations 106 and an access point 104. In some aspects, the process 800 discussed below with respect to FIG. 8 may be performed by the wireless device 202. For example, in some aspects, the memory 206 may store instructions that configure the processor 204 to perform one or more of the functions discussed below with respect to FIG. 8.

Some aspects of process 800 provide a method of scheduling an UL MU-MIMO transmission opportunity.

In block 805, an access point 104 transmits a first trigger message to a plurality of stations 106. The first trigger message requests that the STAs 106 each transmit a second message to the AP 104. In some embodiments, the second message is requested to include information about each STA 106 of the plurality of STAs 106 or a channel between each STA 106 of the plurality of STAs 106 and the AP 104 (e.g., in response to BSRP trigger frames). In some embodiments, the first trigger message corresponds to the trigger frames 602 and/or 702.

In block 810, the AP 104 receives the second messages from the STAs 106. At block 815, the AP 104 estimates or obtains one or more parameters for each station 106 (or the communication link between the AP 104 and each STA 106) based on the second messages.

At block 820, the AP 104 generates a schedule for the STAs 106 to transmit data in an UL MU-MIMO transmission to the AP 104. The generated schedule may include or indicate at least a subset of the plurality of STAs 106 of at least one STA 106. At block 825, the AP 104 transmits a second trigger message to the STAs 106. The second trigger message may identify the subset of the plurality of STAs 106 that are scheduled to transmit data uplink to the AP 104 during the UL MU-MIMO transmission. The second trigger message may also indicate or identify a period of time during which the UL MU-MIMO transmission is to occur. At block 830, the AP 104 receives data from the subset of the STAs 106 during the UL MU-MIMO transmission.

An apparatus for scheduling an UL MU-MIMO transmission opportunity may perform one or more of the functions of method 800, in accordance with certain implementations described herein. The apparatus may comprise means for transmitting a first trigger message to a plurality of stations, the first trigger message requesting that the stations each transmit a second message to the apparatus, wherein each station of the plurality of stations communicates with the apparatus over one of a plurality of communication links. In certain implementations, the means for transmitting a first trigger message can be implemented by one or more of the processor 204, the memory 206, the DSP 220, the transmitter 210, the transceiver 214, and the antenna 216 (FIG. 2). In some implementations, the means for transmitting a first trigger message can be configured to perform the functions of block 805 (FIG. 8). The apparatus may further comprise means for receiving the second messages from one or more responding stations of the plurality of stations. In certain implementations, the means for receiving the second messages can be implemented by the one or more of the processor 204, the memory 206, the DSP 220, the signal detector 218, the receiver 212, the transceiver 214, and the antenna 216. In certain implementations, the means for receiving the second message can be configured to perform the functions of block 810. The apparatus may further comprise means for estimating or obtaining, based on the second messages, one or more parameters for each responding station or each communication link between the apparatus and each responding station. In certain implementations, the means for estimating or obtaining can be implemented by one or more of the processor 204, the memory 206, and the DSP 220. In certain implementations, the means for estimating and obtaining can be configured to perform the functions of block 815. The apparatus may further comprise means for generating a schedule for the stations to transmit data in an UL MU-MIMO transmission opportunity to the apparatus, wherein the schedule indicates at least a subset of the plurality of stations. The means for generating a schedule can be implemented by one or more of the processor 204, the memory 206, the DSP 220, and the user interface 222. In certain implementations, the means for generating a schedule can be configured to perform the functions of block 820. The apparatus may further comprise means for transmitting a second trigger message to the plurality of stations, the second trigger message identifying the subset of the plurality of stations that are scheduled to transmit UL data to the access point during the UL MU-MIMO transmission opportunity. The means for transmitting a second trigger can be implemented by one or more of the processor 204, the memory 206, the DSP 220, the transmitter 210, the transceiver 214, and the antenna 216. In certain implementations, the means for transmitting a second trigger message can be configured to perform the functions of block 825. The apparatus may further comprise means for receiving data during the UL MU-MIMO transmission opportunity from the subset of the plurality of stations. The means for receiving data can be implemented by one or more of the processor 204, the memory 206, the DSP 220, the signal detector 218, the receiver 212, the transceiver 214, and the antenna 216. In certain implementations, the means for receiving data can be configured to perform the functions of block 830.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

In the above description, reference numbers may have been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor or any commercially available processor, controller, microcontroller or state machine. A processor may also be implemented as a combination of computing devices (e.g., a combination of a DSP and a microprocessor, a plurality of microprocessors, one or more microprocessors in conjunction with a DSP core, or any other such configuration).

In one or more aspects, the functions described may be implemented in hardware, software, firmware, or any combination thereof. If implemented in software, the functions may be stored on or transmitted over as one or more instructions or code on a computer-readable medium.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method of scheduling an uplink multi-user multiple-in, multiple-out (UL MU-MIMO) transmission opportunity, comprising:
transmitting, by an access point, a first trigger message to a plurality of stations, the first trigger message requesting that the stations each transmit a second message to the access point, wherein each station of the plurality of stations communicates with the access point over one of a plurality of communication links;
receiving, by the access point, the second messages from one or more responding stations of the plurality of stations;
estimating or obtaining, based on the second messages, one or more parameters for each responding station or each communication link between the access point and each responding station;
generating a schedule for the stations to transmit data in an UL MU-MIMO transmission to the access point, wherein the schedule indicates at least a subset of the plurality of stations;
transmitting a second trigger message to the plurality of stations, the second trigger message identifying the subset of the plurality of stations that are scheduled to transmit UL data to the access point during the UL MU-MIMO transmission opportunity; and
receiving data during the UL MU-MIMO transmission opportunity from the subset of the plurality of stations.

2. The method of claim 1, wherein the first trigger message comprises one of a basic trigger frame and a buffer status report poll (BSRP) frame.

3. The method of claim 2, wherein the second trigger message includes a block acknowledgement when the first trigger message is the regular trigger frame and does not include the block acknowledgement when the first trigger message is the BSRP frame.

4. The method of claim 1, wherein the one or more parameters comprises at least one of buffer status information, clock frequency offset (CFO) errors, channel correlation metrics, received signal strength indicators (RSSIs), error vector magnitudes (EVMs), and packet error rates (PERs).

5. The method of claim 4, wherein the subset of the plurality of stations is scheduled based at least in part on channel correlation between stations of the plurality of stations.

6. The method of claim 1, wherein the schedule is generated based at least in part on the one or more parameters.

7. The method of claim 1, further comprising estimating long-term averages for the one or more parameters based on the one or more parameters.

8. The method of claim 7, wherein the schedule is generated based at least in part on the long-term averages for the one or more parameters.

9. The method of claim 1, further comprising selecting a modulation coding scheme (MCS) for each of the subset of the plurality of stations.

10. The method of claim 1, wherein the first trigger message specifies one or more parameters of one or more of a guard interval and a long training field and further comprising determining whether the one or more parameters can be improved with specific GI and/or LTF parameters.

11. The method of claim 1, wherein the first trigger message is transmitted based on one or more of a pre-determined period, a lack of updates to the subset of the plurality of stations scheduled to transmit data to the access point, a change in one or more of the parameters beyond a threshold value, and a dynamic need.

12. An apparatus for scheduling an uplink multi-user multiple-in, multiple-out (UL MU-MIMO) transmission opportunity, comprising:
a communication circuit configured to:
transmit a first trigger message to a plurality of stations, the first trigger message requesting that the stations each transmit a second message to the access point, and
receive the second messages from one or more responding stations of the plurality of stations,
wherein each station of the plurality of stations communicates with the communication circuit over one of a plurality of communication links; and
a processing circuit configured to:
estimate or obtain, based on the second messages, one or more parameters for each responding station or each communication link between the communication circuit and each responding station; and
generate a schedule for the stations to transmit data in an UL MU-MIMO transmission to the communication circuit, wherein the schedule indicates at least a subset of the plurality of stations,
wherein the communication circuit is further configured to transmit a second trigger message to the plurality of stations, the second trigger message identifying the subset of the plurality of stations that are scheduled to transmit UL data to the communication circuit during the UL MU-MIMO transmission opportunity and receive data during the UL MU-MIMO transmission opportunity from the subset of the plurality of stations.

13. The apparatus of claim 12, wherein the first trigger message comprises one of a basic trigger frame and a buffer status report poll (BSRP) frame.

14. The apparatus of claim 13, wherein the second trigger message includes a block acknowledgement when the first trigger message is the regular trigger frame and does not include the block acknowledgement when the first trigger message is the BSRP frame.

15. The apparatus of claim 12, wherein the one or more parameters comprises at least one of buffer status information, clock frequency offset (CFO) errors, channel correlation metrics, received signal strength indicators (RSSIs), error vector magnitudes (EVMs), and packet error rates (PERs).

16. The apparatus of claim 15, wherein the subset of the plurality of stations is scheduled based at least in part on channel correlation between stations of the plurality of stations.

17. The apparatus of claim 12, wherein the schedule is generated based at least in part on the one or more parameters.

18. The apparatus of claim 12, wherein the processor is further configured to estimate long-term averages for the one or more parameters based on the one or more parameters.

19. The apparatus of claim 18, wherein the schedule is generated based at least in part on the long-term averages for the one or more parameters.

20. The apparatus of claim 12, wherein the processor is further configured to select a modulation coding scheme (MCS) for each of the subset of the plurality of stations.

21. The apparatus of claim 12, wherein the first trigger message specifies one or more parameters of one or more of a guard interval and a long training field and further comprising determining whether the one or more parameters can be improved with specific GI and/or LTF parameters.

22. The apparatus of claim 12, wherein the first trigger message is transmitted based on one or more of a pre-determined period, a lack of updates to the subset of the plurality of stations scheduled to transmit data to the communication circuit, a change in one or more of the parameters beyond a threshold value, and a dynamic need.

23. An apparatus for scheduling an uplink multi-user multiple-in, multiple-out (UL MU-MIMO) transmission opportunity, comprising:
means for transmitting a first trigger message to a plurality of stations, the first trigger message requesting that the stations each transmit a second message to the apparatus, wherein each station of the plurality of stations communicates with the apparatus over one of a plurality of communication links;
means for receiving the second messages from one or more responding stations of the plurality of stations;
means for estimating or obtaining, based on the second messages, one or more parameters for each responding station or each communication link between the apparatus and each responding station;
means for generating a schedule for the stations to transmit data in an UL MU-MIMO transmission opportunity to the apparatus, wherein the schedule indicates at least a subset of the plurality of stations;
means for transmitting a second trigger message to the plurality of stations, the second trigger message identifying the subset of the plurality of stations that are scheduled to transmit UL data to the access point during the UL MU-MIMO transmission opportunity; and
means for receiving data during the UL MU-MIMO transmission opportunity from the subset of the plurality of stations.

24. The apparatus of claim 23, wherein the first trigger message comprises one of a basic trigger frame and a buffer status report poll (BSRP) frame.

25. The apparatus of claim 24, wherein the second trigger message includes a block acknowledgement when the first trigger message is the regular trigger frame and does not include the block acknowledgement when the first trigger message is the BSRP frame.

26. The apparatus of claim 23, wherein the one or more parameters comprises at least one of buffer status information, clock frequency offset (CFO) errors, channel correlation metrics, received signal strength indicators (RSSIs), error vector magnitudes (EVMs), and packet error rates (PERs).

27. The apparatus of claim 26, wherein the subset of the plurality of stations is scheduled based at least in part on channel correlation between stations of the plurality of stations.

28. The apparatus of claim 23, wherein the schedule is generated based at least in part on the one or more parameters.

29. The apparatus of claim 23, further comprising means for estimating long-term averages for the one or more parameters based on the one or more parameters.

30. The apparatus of claim 29, wherein the schedule is generated based at least in part on the long-term averages for the one or more parameters.

31. The apparatus of claim 23, further comprising means for selecting a modulation coding scheme (MCS) for each of the subset of the plurality of stations.

32. The apparatus of claim 23, wherein the first trigger message specifies one or more parameters of one or more of a guard interval and a long training field and further comprising determining whether the one or more parameters can be improved with specific GI and/or LTF parameters.

33. The apparatus of claim 23, wherein the first trigger message is transmitted based on one or more of a pre-determined period, a lack of updates to the subset of the plurality of stations scheduled to transmit data to the apparatus, a change in one or more of the parameters beyond a threshold value, and a dynamic need.
